(19) United States
(12) Patent Application Publication
(10) Pub. No.: US 2026/0178898 A1
(43) Pub. Date: Jun. 25, 2026

(54) TEXT-TO-IMAGE AND IMAGE-TO-TEXT DUAL DIFFUSION MODEL

(71) Applicant: Lemon Inc., Grand Cayman (KY)

(72) Inventors: Henry Li, Los Angeles, CA (US); Zijie Li, Los Angeles, CA (US); Peng Wang, Los Angeles, CA (US); Linjie Yang, Los Angeles, CA (US)

(21) Appl. No.: 19/093,017

(22) Filed: Mar. 27, 2025

Related U.S. Application Data
(60) Provisional application No. 63/736,505, filed on Dec. 19, 2024.

(51) Int. Cl. G06N 3/08; G06F 40/10; G06N 3/045; G06T 11/00

(52) U.S. Cl. CPC G06N 3/08; G06F 40/10; G06N 3/045; G06T 11/00

(57) ABSTRACT

A computing system is provided, including one or more processing devices configured to, during an inferencing phase, receive an input image at a dual diffusion model. The one or more processing devices are further configured to process the input image at the dual diffusion model to compute output text. The one or more processing devices are further configured to output the output text. The dual diffusion model has been computed during a training phase by finetuning a text-to-image (T2I) diffusion model, the finetuning having been performed using a finetuning dataset that includes a plurality of image-text pairs. The finetuning has further utilized a loss function that includes an image distribution loss term and a text distribution loss term.

### CROSS REFERENCE TO RELATED APPLICATIONS

This application claims priority to U.S. Provisional Patent Application Ser. No. 63/736,505, filed Dec. 19, 2024, the entirety of which is hereby incorporated herein by reference for all purposes.

### BACKGROUND

A multimodal generative modeling revolution is currently underway. Diffusion models have become industry leaders for generating high-fidelity images from text descriptions, enabling the accurate modeling and sampling of complex and high-dimensional distributions of images given text. Conversely, autoregressive next-token prediction models have achieved groundbreaking performance both in pure text generation and reasoning, and in visually grounded text generation with language models.

### SUMMARY

According to one aspect of the present disclosure, a computing system is provided, including one or more processing devices configured to, during an inferencing phase, receive an input image at a dual diffusion model. The one or more processing devices are further configured to process the input image at the dual diffusion model to compute output text. The one or more processing devices are further configured to output the output text. The dual diffusion model has been computed during a training phase by finetuning a text-to-image (T2I) diffusion model, the finetuning having been performed using a finetuning dataset that includes a plurality of image-text pairs. The finetuning has further utilized a loss function that includes an image distribution loss term and a text distribution loss term.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A schematically shows a computing system during training of a diffusion backbone included in a dual diffusion model, according to one example embodiment.

FIG. 1B shows computing system during training of the diffusion backbone to perform image-conditioned text denoising, according to the example of FIG. 1A.

FIG. 1C shows the computing system during training of the diffusion backbone to perform text-conditioned image denoising, according to the example of FIG. 1A.

FIG. 2 schematically shows the computing system when the dual diffusion model is executed during an inferencing phase, according to the example of FIG. 1A.

FIG. 3 schematically shows text masking performed at the dual diffusion model during an image captioning task and a visual question answering task, according to the example of FIG. 2.

FIG. 4 shows a question-answering example in which an input image and conditioning input text are used to generate an output text at the dual diffusion model, according to the example of FIG. 2.

FIG. 5 schematically shows an example of image-to-text denoising performed at the dual diffusion model over a plurality of denoising iterations, according to the example of FIG. 2.

FIG. 6A shows a flowchart of a method for use with a computing system to perform I2T and T2I generation at a dual diffusion model, according to the example of FIG. 1A.

FIGS. 6B-6E show additional steps of the method of FIG. 6A that may be performed in some examples.

FIG. 7 shows a schematic view of an example computing environment in which the computing system of FIG. 1 may be instantiated.

### DETAILED DESCRIPTION

Recent advances in multimodal models raise the question: can these existing image-to-text (I2T) or text-to-image (T2I) systems be modified to reason with and generate data in the reverse direction? A positive answer would suggest the possibility of producing a fully multimodal model that is able to understand, reason with, and sample from conditional distributions between modalities in an omnidirectional manner. Moreover, unifying these generative frameworks under a single model with shared parameters can confer a multitude of downstream benefits including improved reasoning and simplified implementation.

With autoregressive next-token prediction models, this query has already been answered resoundingly in the affirmative, as evidenced by a multitude of studies demonstrating T2I capabilities of finetuned generative language models. These capabilities are in part due to the known next-token generative capabilities of autoregressive models with visual tokens.

In contrast, with diffusion models, there has been surprisingly little evidence of a similar reverse capacity. Until recently, generative diffusion models have struggled with language modeling due to the lack of an empirically performant discrete diffusion process on text tokens, despite continued research in this area. At present, multimodal diffusion models either exhibit limited text reasoning capabilities and partial text diffusion, which requires an autoregressive model to decode denoised text latents, or are structured as add-ons to pretrained generative language models fine-tuned in conjunction with a diffusion loss, thereby still relying entirely on next-token prediction for text generation.

The present disclosure revisits the above-mentioned question and presents a dual-branch diffusion model based on the multimodal diffusion transformer (MM-DiT) architecture. The MM-DiT architecture is modified to output diffusion targets on both image and text modalities of the neural network. The model is then trained to perform continuous latent-space diffusion on the image branch and discrete masked token diffusion on the text branch. The implementation presented herein, referred to as a dual diffusion transformer, also allows for controllable infilling in the token space, enabling visual question answering and vision language assistance, which prior diffusion-based models were incapable of. Accordingly, the dual diffusion transformer is an end-to-end multimodal diffusion model trained to perform full-featured I2T and T2I generation.

The dual diffusion transformer framework is compatible with existing diffusion foundation models, which allows the model to be initialized with pretrained checkpoints. The dual diffusion transformer also shows remarkably fast adaptation capabilities of the proposed architecture to text generation tasks, producing meaningful text output in under 25B text tokens when initialized with a pretrained diffusion model checkpoint.

The contributions of the present disclosure can be summarized as follows:

A fully end-to-end cross-modal diffusion model that unifies image and text diffusion under a single transformer.

A simple, elegant, and easy-to-implement joint loss function that simultaneously trains the conditional text and image modalities in a unified, end-to-end fashion.

High performance on an expanded set of multimodal tasks including image generation, visual captioning, and visual question answering using a diffusion-only model, significantly improving on the capabilities and performance of prior multimodal diffusion models.

The following table shows a side-by-side comparison between the backbones and supported features of the dual diffusion transformer compared to those of existing diffusion-based multimodal methods.

| | Modality | | Task | | Visual |
|---|---|---|---|---|---|
| | Image | Text | Image | Image | Question |
| | backbone | backbone | Gen. | Cap. | Answering |
| Model 1 | Diffusion | Diff. + AR | Yes | Yes | No |
| Model 2 | Diffusion | Diff. + AR | Yes | Yes | No |
| Model 3 | Diffusion | AR | Yes | Yes | Yes |
| Model 4 | Diffusion | AR | Yes | Yes | Yes |
| Dual diff. | Diffusion | Diffusion | Yes | Yes | Yes |

The following discussion provides background information related to diffusion models. Diffusion models are trained to compute a likelihood given by:

$${p}_{θ} ( x ) = \int {p}_{θ} ( {x}_{0 : T} ) {dx}_{1 : T}$$

In the above equation, the data x₀:=x are related to a set of latent variables x_{1:T} by a diffusion process that gradually corrupts the original data.

Continuous diffusion models operate on continuous vectors by learning to reverse the following noise-corruption forward process:

$${x}_{t} = {α}_{t} x + {σ}_{t} ϵ \qquad ( 1 )$$

In the above equation, αₜ and σₜ are time-dependent scalar parameters for which αₜ, σₜ>0 and αₜ/σₜ increases monotonically. ϵ is an appropriately selected i.i.d. noise variable. In score-based diffusion models, αₜ, σₜ are determined by a forward stochastic differential equation (SDE) that pushes xₜ toward the normal distribution [symbol] (0, I) as t [symbol] ∞. New samples can be generated by learning the reverse process through estimation of the score function ∇ log pₜ(xₜ).

Alternatively, the following ordinary differential equation (ODE) can be derived:

$${\dot{x}}_{t} = v ( {x}_{t} , t ) \qquad ( 2 )$$

In the above equation, v is a velocity field given by:

$$v ( {x}_{t} , t ) = {\dot{α}}_{t} x + {\dot{σ}}_{t} ϵ$$

The ODE pushes the distribution of xₜ from p₀ to p_{T}. To generate new samples, a neural network can be used to approximate the velocity field v and then integrate the ODE backward in time starting from x_{T}˜ [symbol] (0, I). A common choice of αₜ, σₜ in flow matching models is αₜ=1−t, σₜ=t. This choice gives v=ϵ−x, which corresponds to the optimal transport interpolant between two distributions p₀ and p₁. The neural network for regressing the velocity field v in the above ODE is trained by approximating a minimum of the following flow matching loss function:

$${L}_{FM} = {𝔼}_{t , q ( {x}_{t} \vert x )} {‖ {v}_{θ} ( {x}_{t} , t ) - ( ϵ - x ) ‖}_{2}^{2} \qquad ( 3 )$$

Recent work has demonstrated the high performance of flow matching models on text-to-image generation.

In discrete diffusion, the variate x∈ [symbol] × . . . × [symbol] has finite support over the product space of [symbol] ={1, . . . , N}, where in language models, N is the vocabulary size of the token embedding. The I2T modeling task may be performed by applying a continuous relaxation to the discrete variable. This continuous relaxation produces a continuous reformulation of discrete diffusion, thereby allowing the continuous diffusion techniques discussed above to be used. This continuous reformulation simplifies diffusion modeling but introduces a significant source of error in the mapping between discrete and relaxed continuous states.

In another approach to discrete diffusion, the diffusion process is extended to a discrete token space, which removes the need for the aforementioned mapping via a specialized discrete diffusion formulation. Leveraging continuous-time Markov chain (CTMC) theory, the marginal distributions pₜ can be described by a family of linear ordinary differential equations:

$$\frac{{dp}_{t}}{dt} = {Q}_{t} {p}_{t} \qquad ( 4 )$$

In these ODEs, p₀≈p_{data}, p₁≈p_{stationary}, and Qₜ is a time-dependent sequence of transition matrices that provides a mapping between the two distributions.

Absorbing state (i.e., masked) diffusion is a discrete diffusion approach that has high performance on text modeling. The masked diffusion formulation induces the following posterior at timesteps 0<s<t:

$$q ( {x}_{s} \vert {x}_{t} , x ) = \{ \begin{matrix}Cat ( {x}_{s} \vert {x}_{t} ) {x}_{t} \neq m \\ Cat ( {x}_{s} \vert \frac{( 1 - {α}_{s} ) m + ( {α}_{s} - {α}_{t} ) x}{1 - {α}_{t}} ) o . w .\end{matrix} \qquad ( 5 )$$

In the above equation, the clean data x is a discrete variable specified as a one-hot vector with N categories. The clean data x has a marginal given by:

$$q ( {x}_{t} \vert x ) = Cat ( {x}_{t} \vert {α}_{t} x + ( 1 - {α}_{t} ) m ) \qquad ( 6 )$$

In the above equations, Cat(⋅|π) denotes the categorical distribution over different classes with probability π, and m denotes the mask absorbing state.

To reverse the noising process, the density ratio

$${{s}_{θ} ( x )}_{y} \approx \frac{{p}_{t} ( x )}{{p}_{t} ( y )}$$

may be modeled given two sequences x,y∈ [symbol] × . . . × [symbol] , as in Uniform Score-Entropy Discrete Diffusion (SEDD). Alternatively, the denoised variate x_{θ}(xₜ, αₜ)≈x may be modeled directly, as in a masked diffusion model. In the former, the modeled density ratios induce a specialized reverse transition matrix Q̅ₜ that can be leveraged in equation (4). In the latter, x_{θ} can be directly substituted for x in equation (5).

In the approach discussed herein, zero probability is enforced on the mask state m, and all unmasked states are kept unchanged during reverse sampling. The log-likelihood log p_{θ}(x) therefore has a simplified (negative) variational lower bound under the continuous-time limit:

$${L}_{NELBO} = {𝔼}_{q ( {x}_{t} \vert x )} [ {\int }_{0}^{1} \frac{{α}_{t}^{′}}{1 - {α}_{t}} log ( {x}_{θ} ( {x}_{t} , {α}_{t} ) \cdot x ) dt ] \qquad ( 7 )$$

Monte Carlo sampling may be used to approximate the loss function in equation (7). A log-linear schedule with αₜ=1−t may be used, and Monte Carlo sampling may be performed to estimate the expectation in the above equation.

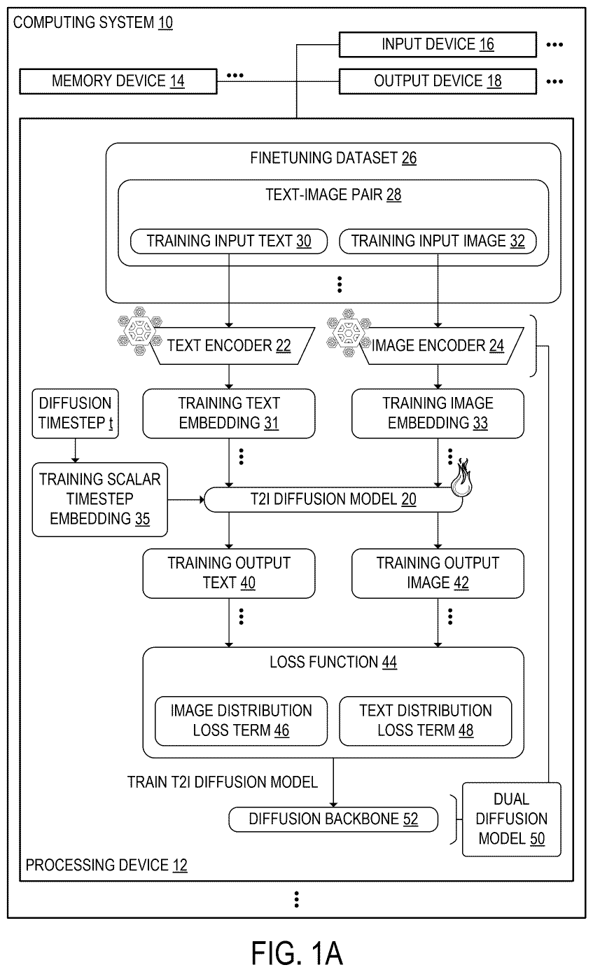

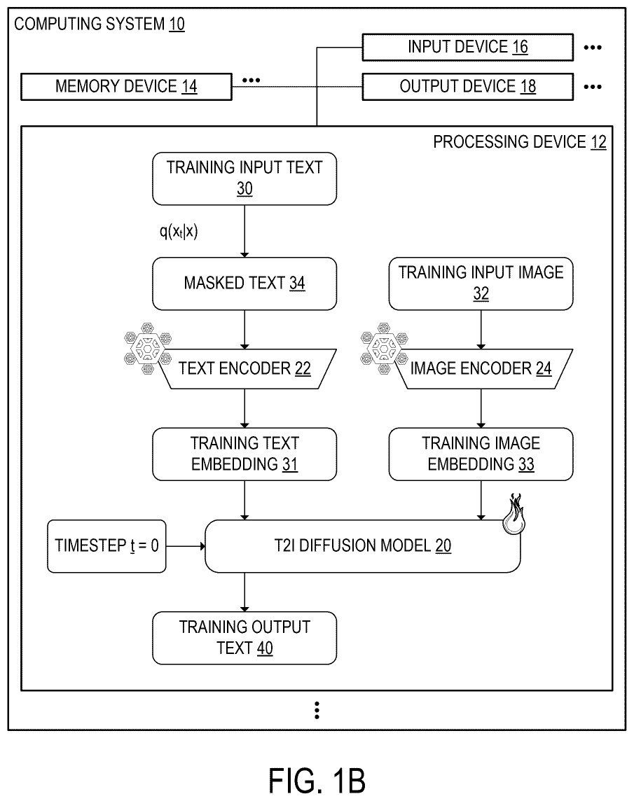

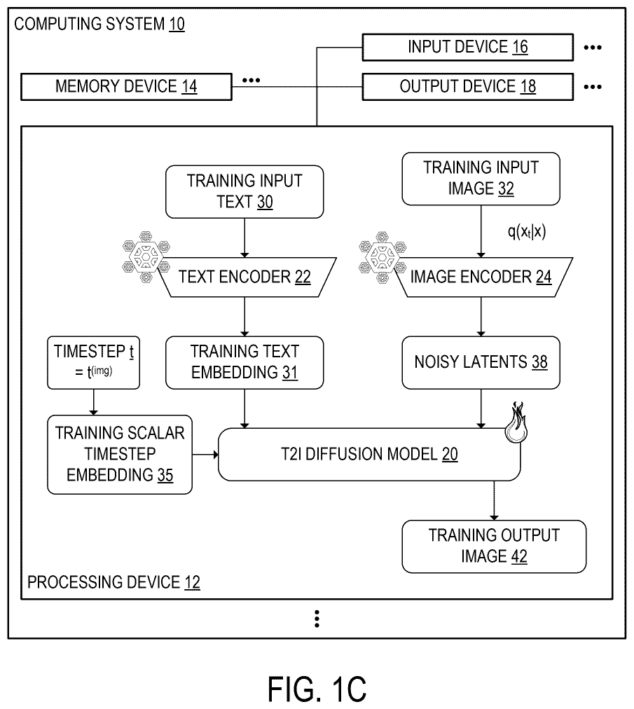

The training of the dual diffusion transformer is discussed below with reference to FIG. 1A, in which the dual diffusion transformer is the dual diffusion model 50. As discussed above, the dual diffusion model 50 is an end-to-end multimodal diffusion model with a unified diffusion backbone 52 that jointly models image and text distributions. Specifically, given an image x^{(img)} and text x^{(txt)}, the dual diffusion model 50 is configured to model the conditional distributions p(x^{(img)}|x^{(txt)}) and p(x^{(txt)}|x^{(img)}). The former modeling task is referred to as text-to-image generation, and the latter is performed in various image understanding tasks such as captioning and visual question answering.

FIG. 1A schematically shows a computing system 10 including one or more processing devices 12 and one or more memory devices 14. For example, the one or more processing devices 12 may include one or more central processing units (CPUs), graphics processing units (GPUs), and/or neural processing units (NPUs). The one or more memory devices 14 may include volatile memory and/or non-volatile storage. In the example of FIG. 1, the computing system 10 further includes one or more input devices 16 and one or more output devices 18 via which a user may interact with the computing system 10. In some examples, the computing system 10 is implemented in a single physical computing device, whereas in other examples, the computing system 10 is implemented across multiple physical computing devices, such as in a server-client configuration.

FIG. 1A shows the computing system 10 when the one or more processing devices 12 are configured to finetune a text-to-image (T2I) diffusion model 20 during a training phase to obtain the dual diffusion model 50. The T2I diffusion model 20 is finetuned using a finetuning dataset 26 that includes a plurality of image-text pairs 28, each of which includes a training input text 30 and a training input image 32. In some examples, to reduce the computational costs associated with processing high-resolution images, the one or more processing devices 12 are further configured to compress the training input images 32 from raw pixel space into a spatially compressed latent space obtained from a variational-autoencoder (VAE) trained with discriminator loss and KL-divergence regularization.

The T2I diffusion model 20 is finetuned using a loss function 44 that includes an image distribution loss term 46 and a text distribution loss term 48, as discussed in further detail below. This finetuning converts the T2I diffusion model 20 into a diffusion backbone 52 included in the dual diffusion model 50.

In addition to the diffusion backbone 52, the dual diffusion model 50 further includes a text encoder 22 and an image encoder 24. The text encoder 22 and the image encoder 24 are pretrained models with weights that are kept frozen during training of the diffusion backbone 52. At the text encoder 22, the one or more processing devices 12 are configured to compute respective training text embeddings 31 of the training input texts 30 included in the image-text pairs 28. At the image encoder 24, the one or more processing devices 12 are configured to compute respective training image embeddings 3 of the training input images 32.

The one or more processing devices 12 are further configured to input the training text embeddings 31 and the training image embeddings 33 into the T2I diffusion model 20, which is configured to process the training text embeddings 31 and the training image embeddings 33 over a plurality of diffusion timesteps t. In addition, the one or more processing devices 12 are configured to compute a training scalar timestep embedding 35 of the current diffusion timestep t and input the training scalar timestep embedding 35 into the T2I diffusion model 20 as an additional input. The training scalar timestep embedding 35 may be input into the T2I diffusion model 20 at each of the diffusion timesteps t.

At the T2I diffusion model 20, the one or more processing devices 12 are configured to compute a plurality of training output texts 40 and a plurality of training output images 42. The one or more processing devices 12 are further configured to use the training output texts 40 and the training output images 42 to compute a value of a loss function 44. The one or more processing devices 12 are further configured to train the T2I diffusion model 20 by performing gradient descent with respect to the loss function 44. Thus, the one or more processing devices 12 are configured to finetune the T2I diffusion model 20 to obtain the diffusion backbone 52 of the dual diffusion model 50.

The architecture of the dual diffusion model 50 is discussed below. The dual diffusion model 50 is a transformer-based model including two branches: a first branch that processes image tokens and a second branch that processes text tokens. The image and text tokens attend to each other in every attention layer. In the dual diffusion model 50, the output of the image branch is the prediction of velocity defined in equation (2) with text conditioning. The output for the text branch is the x^{(txt)} prediction with image conditioning. A training scalar timestep embedding 35 modulates the feature map of each layer via AdaLN (adaptive layernorm). The training scalar timestep embedding 35 is input into the model during image generation but not text generation, since xₜ^{(txt)} already implicitly carries an indication of the signal-to-noise ratio (the number of mask tokens in the sequence).

In addition, as discussed above, a text encoder 22 may be added on top of the text branch of the dual diffusion model 50. The text encoder 22 may utilize bidirectional attention. Incorporating the text encoder 22 into the DiT model may allow a pretrained text-to-image model to be easily adapted as a pretrained backbone for the dual diffusion transformer. The text encoder 22, in such examples, does not use a causal mask, since a causal mask would violate the constraints of the masked diffusion process.

FIG. 1B shows computing system 10 during training of the diffusion backbone 52 to perform image-conditioned text denoising. During training for image-conditioned text denoising, the training text input 30 is randomly masked to obtain masked text 34. In contrast, the training input image 32 is kept noise-free. In addition, in the example of FIG. 1B, the one or more processing devices 12 do not input the training scalar timestep embeddings 35 into the T2I diffusion model 20 during training on the image-conditioned text denoising task.

FIG. 1C shows the computing system 10 during training of the diffusion backbone 52 to perform text-conditioned image denoising. During training for text-conditioned image denoising, the one or more processing devices 12 are configured to apply random noise to the training input image 32, and to compute noisy latents 38 at the image encoder 24 based at least in part on the noised training input image. In contrast, the training input text 30 is kept noise-free. The T2I diffusion model 20 is configured to receive the training scalar timestep embedding 35 during training on the text-conditioned image denoising task.

As shown in FIG. 1A, the dual diffusion model 50 has a joint training objective for image-text joint modeling. This joint training objective is a joint denoising target that includes an image distribution loss term 46 and a text distribution loss term 48. Flow matching is used to learn the conditional distribution of images, and masked diffusion is used to learn the conditional distribution of text. During training, corrupted samples xₜ_{^{(img)}} and xₜ_{^{(txt)}} are sampled from the corresponding forward corruption processes q(xₜ|x) defined in equations (1) and (6) respectively. The diffusion loss for each modality is then computed as:

$$\begin{matrix}{L}_{image} = {𝔼}_{t , {q}^{( img )}} {‖ {v}_{θ} ( {x}_{t}^{( img )} , t , {x}^{( txt )} ) - ( ϵ - {x}^{( i m g )} ) ‖}_{2}^{2} \\ {L}_{txt} = {𝔼}_{{q}^{( txt )}} [ \frac{- 1}{K} {\sum }_{i = 1}^{K} log [ {x}_{θ} ( {x}_{{t}_{i}}^{( txt )} , {x}^{( img )} ) \cdot x ] / {t}_{i} ]\end{matrix} \qquad ( 8 )$$

Antithetic sampling is used for text diffusion timesteps tᵢ by uniformly discretizing (δ, 1] into K points, where δ is a small number that is used to avoid numerical instability. For image diffusion, t is sampled from the log-normal distribution. The conditioning samples are not corrupted during training. As such, the image diffusion timestep is set to zero when predicting the text distribution.

The overall dual modality training loss is a simple weighted combination of the above single-modality diffusion loss terms:

$${L}_{dual} = {L}_{image} + {λ}_{txt} {L}_{txt} \qquad ( 9 )$$

In this equation, λₜₓₜ is a hyperparameter.

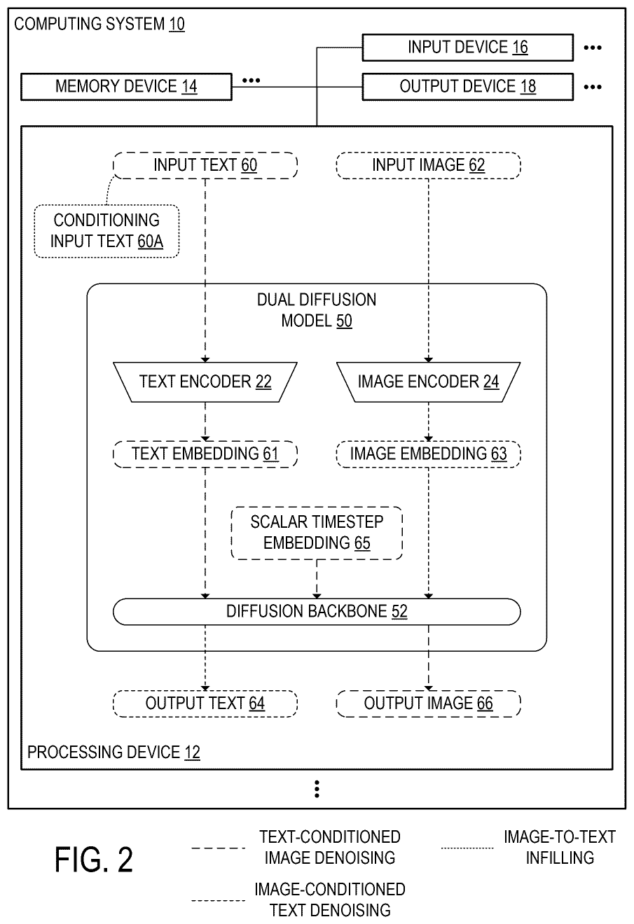

FIG. 2 schematically shows the computing system 10 when the one or more processing devices 12 are configured to execute the dual diffusion model 50 during an inferencing phase. Three types of sampling-based inference can be used for different vision-language tasks, as discussed below.

To perform text-guided image generation, i.e., x˜p(x^{(img)}|x^{(txt)}), the dual diffusion model 50 may use the classifier-free guidance (CFG) technique to sample from the conditional distribution

$$p ( {x}_{t}^{( img )} \vert {x}^{( txt )} ) .$$

CFG includes re-weighting the velocity prediction:

$${\tilde{v}}_{t} = {sv}_{θ} ( {x}_{t}^{( img )} , t , {x}^{( txt )} ) + ( 1 - s ) {v}_{θ} ( {x}_{t}^{( img )} , t , ∅ ) \qquad ( 10 )$$

In the above equation, s is a hyperparameter that controls the scale of the guidance, and Ø is a suitable null embedding (e.g. the embedding of empty text).

As shown in FIG. 2, the one or more processing devices 12 are configured to receive input text 60 at the dual diffusion model 50 and process the input text 60 at the dual diffusion model 50 to compute an output image 66. The input text 60 is processed at the text encoder 22 to compute text embeddings 61, which are input into the diffusion backbone 52. The diffusion backbone 52 computes the output image 66, and the one or more processing devices 12 are further configured to output the output image 66. The one or more processing devices 12 may be configured to perform continuous latent space diffusion at the diffusion backbone 52 of the dual diffusion model 50 when computing the output image 66. The output image 66 may, for example, be output to a graphical user interface (GUI) implemented using the one or more input devices 16 and the one or more output devices 18.

In some examples, as shown in FIG. 2, the one or more processing devices 12 may be further configured to input a respective scalar timestep embedding 65 into the diffusion backbone 52 at each of a plurality of diffusion timesteps t when computing the output image 66. For example, the one or more processing devices 12 may be configured to compute an adaLN of the scalar timestep embedding 65 and the text embedding 61. The one or more processing devices 12 may accordingly condition the denoising on an indication of the amount of denoising that has already been performed on the image.

In I2T generation, to sample images from the conditional distribution, the one or more processing devices 12 may be configured to perform ancestral sampling to draw from the posterior distribution q(xₛ|xₜ, x) in equation (5). Ancestral sampling may be performed by plugging in the prediction

$$x \approx {x}_{θ} ( {x}_{t}^{( txt )} , {x}^{( img )} ; t = 0 ) .$$

Accordingly, the one or more processing devices 12 are configured to receive an input image 62 at the dual diffusion model 50 and process the input image 62 at the dual diffusion model 50 to compute output text 64. The input image 62 is processed at the image encoder 24 to compute image embeddings 63, which are input into the diffusion backbone 52. The diffusion backbone 52 computes the output text 64, and the one or more processing devices 12 are further configured to and output the output text 64 (e.g., to the GUI). The one or more processing devices 12 may be configured to perform discrete diffusion at the diffusion backbone 52 of the dual diffusion model 50 when computing the output text 64.

In image-to-text infilling tasks, both text conditioning information and image conditioning information are available, such as in a visual question answering task where an image and an associated question are provided. Accordingly, in image-to-text infilling, the one or more processing devices 12 are further configured to receive the input text 60 as conditioning input text 60A. The one or more processing devices 12 are further configured to compute the output text 64 at the dual diffusion model 50 based at least in part on the input image 62 and the conditioning input text 60A. In such tasks, the sampling x˜p(x^{(answer)}|x^{(img)},x^{(question)}) is performed. To perform image-to-text infilling, the diffusion prior of the question is initialized with masked tokens. The robust text infilling capabilities of the diffusion backbone 52 are leveraged to complete the sequence by sampling from the conditional distribution.

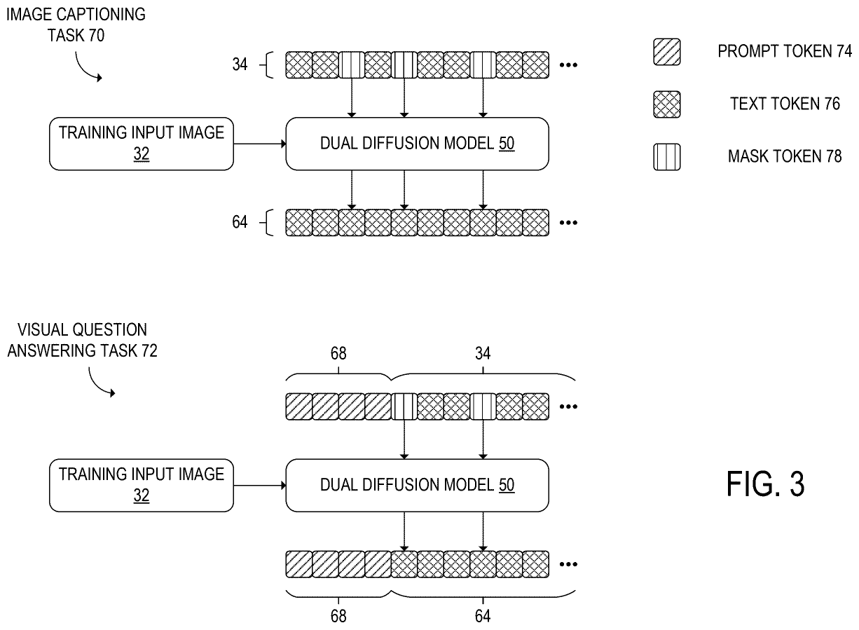

FIG. 3 schematically shows text masking performed at the dual diffusion model 50 during an image captioning task 70 and a visual question answering task 72. Although the dual diffusion model 50 is shown during inferencing in the example of FIG. 3, tokens may also be processed at the dual diffusion model 50 in a corresponding manner during training. In the image captioning task 70, the one or more processing devices 12 are configured to denoise masked text 34 including a plurality of text tokens 76 and a plurality of mask tokens 78. Each output token of the output text 64 in the image captioning task 70 is a text token 76.

In the visual question answering task 72, a plurality of prompt tokens 74 are kept fixed throughout sampling. These prompt tokens 74 are the text tokens included in the question. The one or more processing devices 12 are configured to denoise masked text 34 that has the prompt tokens 74 as a prefix 68. The prefix 68 is also included in the output of the dual diffusion model 50 along with the output text 64.

Experiments were performed to test the performance of the dual diffusion transformer, as discussed below. In these experiments, the dual diffusion transformer was implemented using a pretrained text-to-image model, and the model weights of the dual diffusion transformer were initialized from this pretrained checkpoint. A linear head was added on top of the text branch to perform text denoising. The T5 encoder/tokenizer and the image VAE of the pretrained diffusion model were also used, and the weights of the T5 encoder/tokenizer and the image VAE were kept unchanged throughout all the experiments, except the weights of the mask token embedding in T5. The CLIP text encoders in the pretrained diffusion model were removed due to the causal attention masking performed by the CLIP text encoders. Removing the CLIP text encoders also simplifies the structure of the dual diffusion transformer.

The specialized token <extra_id0> is used in the vocabulary of T5 to represent the mask token in masked diffusion, as this token is used to mark the masked token in the mask pretraining process of original T5 model. By using the <extra_id0> token, the dual diffusion transformer is capable of generating text effectively even without updating the weight of this token embedding. To further reduce the domain gap, the token embedding of <extra_id0> was unfrozen during the second stage of the training.

In contrast to multimodal models that are built upon language models, the dual diffusion transformer is not pretrained on text-only generation. In the preliminary experiments, adding a text-only target (i.e. un-conditional text generation) to the model did not significantly influence its captioning performance.

The dual diffusion transformer was trained in three stages on publicly available datasets. The total number of image-text pairs was approximately 40 M. The respective datasets and training processes of the three stages are listed below. All the training stages used the joint diffusion loss defined in equation (8).

1) Dual diffusion pretraining: the original model was only trained on ambient image-text pairs and not on isolated text data. To adapt the dual diffusion transformer to text generation tasks, the dual diffusion transformer was trained on the joint diffusion loss for 60K iterations with a batch size of 512. The maximum text token length was truncated to 64, and an image resolution of 256 was used. The dataset used in this stage was re-captioned Datacomp-1b. The model used around 30 M images in this stage, which were less than 3% of the total images in the dataset.

2) Continued pretraining on higher-quality data: the masked token embedding in T5 was unfrozen and the model was trained for 200 k iterations on an image understanding dataset with rich textual description. This image understanding dataset included the pretraining dataset from ShareGPT4V (1.3 M images) and OpenImages (a 1.9 M-image subset with object detection annotations) re-captioned by Share-Captioner. The text token length was set to 256 and the image resolution was 256, with a batch size of 512. Finetuning the mask token embedding reduces the domain gap, since the T5 encoder has not been pretrained on sequences filled with high percentages of mask tokens.

Since updating the mask token embedding included backpropagating through the heavy T5 encoder, the mask embedding was frozen after this round of training on the image understanding dataset. The l2 distance between the mask token embeddings from different training iterations did not change much after 100 k iterations.

High-resolution model finetuning was then conducted on the aforementioned image understanding dataset, together with a newly added image generation dataset. A higher-quality dataset of 10 M images (9 M re-captioned LAION-1024 images and 1 M Midjourney images) was used in the high-resolution model finetuning. In this training stage, the image diffusion loss was computed from the high-quality image dataset, whereas the text diffusion loss was computed from the understanding dataset. The model was finetuned for 80K iterations, with image resolution 512, text token length 256, and a batch size of 768. The high-resolution model finetuning stage was performed only for the 512×512 model variant.

3) Visual instruction tuning: the dual diffusion transformer was finetuned on a mixture of instruction-tuning datasets to promote joint text-image conditioned text generation. The LLaVA-Pretrain558K and LLaVA-v1.5-mix-665K visual instruction tuning datasets were combined with the training splits for TextVQA and VizWiz, and the model was trained for 25K iterations. Following the convention in LLaVA-1.5, the dual diffusion transformer was trained to distinguish between long-form answers, short answers, multiple choice answers, and captions via task-specific instruction prompts that come after the question, such as “Answer the question using a single word or phrase,” “Answer with the option's letter from the given choices directly,” or “Describe the image concisely.”

The following table shows the hyperparameters that were used during training of the dual diffusion transformer:

| | | Continued | Continued | |
|---|---|---|---|---|
| | | pretrain | pretrain | |
| | Dual | (mask | (high | Instruction |
| Hyperparam. | pretrain | embeddings) | res.) | tuning |
| Gradient steps | 60k | 200k | 80k | 25k |
| Batch size | 512 | 512 | 768 | 512 |
| LR | 5e−5 | 3e−5 | 3e−5 | 3e−5 |

| | Constant LR | Constant LR | Constant LR | Constant LR |
|---|---|---|---|---|
| Scheduler | with warmup | with warmup | with warmup | with warmup |
| Warmup iters. | 5000 | 1000 | 1000 | 1000 |
| Weight decay | 1e−2 | 1e−2 | 1e−2 | 1e−2 |
| Text loss | 0.2 | 0.2 | 0.2 | 0.3 |
| weight | | | | |

During each of the training stages, the AdamW optimizer was used with the default hyperparameters β₁=0.9 and β₂=0.999. Mixed-precision training (bf16) and fully-sharded data parallelization (with gradient an optimizer states sharded) were used during model training.

Existing multimodal diffusion models perform text diffusion in a CLIP latent space, which hampers their ability to perform text completion. Thus, the use of a CLIP latent space limits the capabilities of such existing multimodal diffusion models on visual question answering and image captioning tasks. The dual diffusion transformer avoids this shortcoming due to its discrete masked diffusion branch, which allows question tokens to be left unmasked throughout sampling. The dual diffusion transformer was accordingly evaluated on a full suite of image-to-text generation tasks, including image captioning and visual question answering benchmarks, as well as long-form visual assistance responses.

The visual understanding capabilities of the dual diffusion transformer were evaluated via the academic question answering benchmarks VQAv2, VizWiz, OKVQA, GQA, POPE, and MME. Due to the short-form nature of the questions, sampling was performed with 16 diffusion steps. The dual diffusion transformer was compared against a selection of multimodal models, including I2T-only and I2T+T2I models. The models used and the results of this experiment are summarized in the following tables:

| | Params. | Text | Image |
|---|---|---|---|
| Model | (#trainable) | Backbone | Backbone |
| Model 5 | 13B | AR | — |
| Model 6 | 13B | AR | — |
| Model 7 | 9B | AR | — |
| Model 8 | 7B | AR | — |
| Model 9 | 9B | AR | — |
| Model 10 | 9B | AR | — |
| Model 11 | 7B | AR | AR |
| Model 12 | 7B | AR | AR |
| Model 13 | 7B | AR | AR |
| Model 3 (256 × 256) | 1.3B | AR | Diffusion |
| Model 3 (512 × 512) | 1.3B | AR | Diffusion |
| Model 14 | 7B | AR | Diffusion |
| Dual diff. (256 × 256) | 2B | Diffusion | Diffusion |
| Dual diff. (512 × 512) | 2B | Diffusion | Diffusion |

| | MS-COCO | VQAv2 | VizWiz | OKVQA | MME | GQA | POPE |
|---|---|---|---|---|---|---|---|
| Model | CIDEr ↑ | Acc. ↑ | Acc. ↑ | Acc. ↑ | Acc. ↑ | Acc. ↑ | Acc. ↑ |
| Model 5 | — | 81.8 | 57.5 | — | 1500.1 | 64.7 | 86.4 |
| Model 6 | — | 65.0 | 19.6 | — | 1293.8 | 41.0 | 85.5 |
| Model 7 | — | 50.9 | — | — | — | — | — |
| Model 8 | — | 78.2 | 38.9 | — | 1487.5 | 57.5 | — |
| Model 9 | 65.5 | 43.5 | — | — | — | — | — |
| Model 10 | 79.4 | 51.8 | 28.8 | 44.7 | — | — | — |
| Model 11 | 61.6 | 47.6 | 37.6 | 23.8 | — | — | — |
| Model 12 | 18.0 | — | — | — | — | — | — |
| Model 13 | — | 55.8 | 11.6 | — | — | 44.8 | 75.2 |
| Model 3 | — | 64.7 | — | — | 1014.9 | 54.2 | 76.2 |
| (256 × 256) | | | | | | | |
| Model 3 | — | 69.4 | — | — | 1097.2 | 58.0 | 80.0 |
| (512 × 512) | | | | | | | |
| Model 14 | 29.0 | — | — | — | — | — | — |
| Dual diff. | — | 59.5 | 19.4 | 28.5 | 897.5 | 55.1 | 79.2 |
| (256 × 256) | | | | | | | |
| Dual diff. | 56.2 | 60.1 | 29.9 | 25.3 | 1124.7 | 59.2 | 84.0 |
| (512 × 512) | | | | | | | |

The above results show that the dual diffusion transformer, as the only diffusion-only multimodal model capable of visual question answering tasks, already has performance that is competitive with recent I2T+T2I models. The dual diffusion transformer, at a resolution of 512 outperforms Model 3 on MME, GQA, and POPE, and approaches the performance of auto-regressive VLMs such as Model 8 and Model 6 despite having a significantly smaller number of trainable parameters.

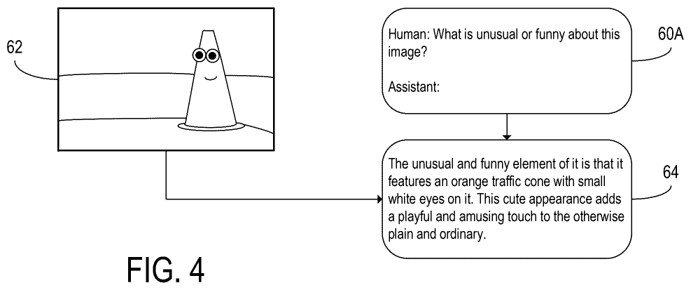

FIG. 4 shows a question-answering example in which an input image 62 and conditioning input text 60A are used to generate an output text 64 at the dual diffusion model 50. In the example of FIG. 4, the dual diffusion transformer accurately answers a textual question related to the contents of the input image 62.

The experiments also tested the text-to-image generation capabilities of the dual diffusion transformer. The 512×512 dual diffusion model was evaluated after the second training stage on the GenEval benchmark, which measures models' prompt-following capabilities. This experiment used the default settings in the pretrained diffusion model checkpoint, which uses an Euler solver with 28 sampling steps and a CFG scale of 7.0. As seen from the results of this experiment, joint diffusion training does not cause catastrophic forgetting. The fine-tuned dual diffusion transformer preserves the performance of the original diffusion model and slightly improves on some metrics such as colors after joint training.

The following table shows the results of the text-to-image generation experiment:

| | Params | | 1- | 2- | | | | Color |
|---|---|---|---|---|---|---|---|---|
| Model | (B) | Overall | object | object | Counting | Colors | Position | attribution |
| Model 15 | 0.6 | 0.48 | 0.98 | 0.50 | 0.44 | 0.80 | 0.08 | 0.07 |
| Model 16 | 0.9 | 0.50 | 0.98 | 0.51 | 0.44 | 0.85 | 0.07 | 0.17 |
| Model 17 | 6.5 | 0.52 | 0.94 | 0.66 | 0.49 | 0.77 | 0.10 | 0.19 |
| Model 18 | 0.9 | 0.55 | 0.98 | 0.74 | 0.39 | 0.85 | 0.15 | 0.23 |
| Model 19 | — | 0.67 | 0.96 | 0.87 | 0.47 | 0.83 | 0.43 | 0.45 |
| Model 20 | — | 0.31 | 0.89 | 0.16 | 0.16 | 0.65 | 0.02 | 0.01 |
| Model 13 | 7 | 0.47 | 0.93 | 0.41 | 0.46 | 0.79 | 0.09 | 0.15 |
| Model 21 | 17 | 0.49 | 0.58 | 0.58 | 0.26 | 0.80 | 0.19 | 0.14 |
| Model 12 | 7 | 0.39 | — | — | — | — | — | — |
| Model 3 | 1.3 | 0.68 | 0.98 | 0.80 | 0.66 | 0.84 | 0.31 | 0.50 |
| Model 4 | 8 | 0.67 | — | — | — | — | — | — |
| Model 22 | 2 | 0.62 | 0.98 | 0.98 | 0.63 | 0.67 | 0.34 | 0.36 |
| Dual diff. | 2 | 0.65 | 0.97 | 0.97 | 0.54 | 0.76 | 0.32 | 0.50 |

The training of T2I diffusion models on large numbers of text-image pairs raises the question of whether the representations learned throughout this process can be transferred to multi-modal understanding tasks. To answer this question, an ablation study was performed on the internal representations of a T2I diffusion model. Several models were adapted into image captioning models. Among different internal layers in Model 22, features from the 18th layer tended to have the highest performance in preliminary experiments. Thus, the 18th layer was used as the output feature layer. A text decoder was added to the features extracted from Model 22 and CLIP. The decoder of Model 2 was finetuned on text reconstruction and kept frozen afterward. The text outputs of the dual diffusion transformer were used directly as results. All the models were trained with a mixture of recaptioned Datacomp, recaptioned OpenImages, and captioning data from ShareGPT4V. The quality of the generated captions was evaluated by using a generative language model to perform visual question answering according to the generated captions.

Accuracy results from the ablation study are listed in the following table:

| Vision | Language | VQAv2 (val) | VQAv2 (val) |
|---|---|---|---|
| encoder | decoder | 0-shot | 32-shot |
| Model 22 feature | Yes | 42.3 | 46.9 |
| (frozen) | | | |
| Model 22 feature | Yes | 45.1 | 50.2 |
| (trainable) | | | |
| Model 23 L/14 | Yes | 50.6 | 54.8 |
| (frozen) | | | |
| Model 2 | Yes | 46.7 | 49.4 |
| Dual diff. | No | 55.0 | 60.3 |

As shown in the ablation study results, directly using diffusion features as the prefix of a language decoder yields lower accuracy compared to language-supervised vision models like Model 23. Unfreezing the parameters of the diffusion backbone slightly improves the performance, but it still does not match the CLIP encoder. This suggests that the representation from image diffusion models is not directly transferrable to the text embedding space in which the decoder-only language model operates.

Instead of leveraging a separate language decoder, the dual diffusion transformer uses the text branch in the MM-DiT architecture to directly model the conditional text distribution, which notably increases accuracy. This boost to performance uncovers an intriguing property of MM-DiT model, and potentially other bidirectional transformers: that these models are accurate representation learners for estimating the likelihoods of multimodal data distributions.

An ablation study was also conducted with respect to the number of text diffusion sampling steps. The influence of the number of sampling steps on the VQA accuracy was studied, using VQAv2 and captioning quality on the COCO dataset. The following table shows the results of the sampling step ablation study:

| Task | T = 4 | 8 | 16 | 32 | 64 | 128 |
|---|---|---|---|---|---|---|
| VQAv2 | 58.8 | 58.0 | 59.3 | 60.5 | 60.0 | 59.6 |
| (Acc.) | | | | | | |
| MS-COCO | 20.2 | 35.3 | 46.5 | 51.3 | 56.2 | 54.5 |
| (CIDEr) | | | | | | |

For VQAV2, which involves short text answers, high accuracy was achieved with relatively few sampling steps. For the captioning task on MS-COCO, performance improved as the number of sampling steps increased.

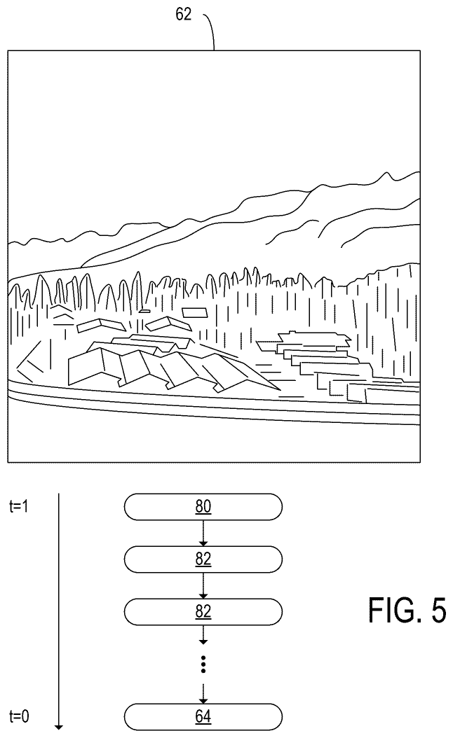

FIG. 5 schematically shows an example of image-to-text denoising performed at the dual diffusion model 50 over a plurality of denoising iterations. The image-to-text denoising starts from an input image 62 and proceeds from t=1 to t=0 over a plurality of denoising timesteps at which respective denoising results are computed starting from an initial masked output 80. These denoising results include a plurality of intermediate denoising results 82 and a final denoising result, which is the output text 64. Examples of the initial masked output 80 and four denoising results are shown below, including three intermediate denoising results 82 and the output text 64. In this example, the intermediate denoising results 82 presented below are selected from a larger number of intermediate denoising results 82 computed over the course of I2T inferencing.

Q: Provide a brief description of the given image. A: [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK] [MASK [MASK] [MASK] [MASK]

Q: Provide a brief description of the given image. A: [MASK] [MASK] [MASK] [MASK] [MASK] [MASK] [MASK] beautiful [MASK] [MASK] taken [MASK] [MASK] [MASK] [MASK] [MASK] [MASK] [MASK] [MASK] [MASK] to [MASK] [MASK] [MASK] [MASK] [MASK] [MASK] [MASK] [MASK] [MASK] [MASK] [MASK] [MASK] of [MASK] [MASK] [MASK] [MASK] [MASK] [MASK] [MASK] [MASK] [MASK] town [MASK] [MASK] [MASK] [MASK] [MASK] [MASK] [MASK]. [MASK] [MASK]′ [MASK] [MASK] ray [MASK] illuminate [MASK] [MASK] [MASK] [MASK] [MASK] a warm [MASK] [MASK] [MASK] [MASK] [MASK]zure [MASK] [MASK] [MASK] [MASK] [MASK] [MASK] [MASK] [MASK] [MASK] [MASK] [MASK]</s> [MASK]</s> [MASK] [MASK] [MASK] [MASK] [MASK] [MASK] [MASK] [MASK] [MASK] [MASK] [MASK] [MASK] [MASK] [MASK]</s> [MASK] [MASK] [MASK] [MASK] [MASK] [MASK] </s> [MASK] [MASK] [MASK] [MASK] [MASK] [MASK] [MASK] </s></s> [MASK] [MASK] [MASK] [MASK] [MASK] [MASK]</s></s> [MASK]

Q: Provide a brief description of the given image. A: [MASK] image [MASK] a serene and beautiful [MASK] scene taken [MASK] [MASK] [MASK] [MASK] [MASK], which appears to be a [MASK] [MASK] [MASK] From [MASK] wooden balcony [MASK] [MASK] of a clear [MASK] [MASK] where the snowy town [MASK] the base [MASK] [MASK] horizon. [MASK] [MASK]′ [MASK] [MASK] ray [MASK] illuminate the landscape [MASK] casting [MASK] a warm glow [MASK] the azure backdrop [MASK]</s></s></s> [MASK] [MASK]</s></s> [MASK]</s></s></s></s></s></s></s></s> [MASK]</s></s> [MASK] [MASK]</s> [MASK] [MASK]</s> [MASK]</s></s></s> [MASK]</s> [MASK]</s></s> [MASK]</s></s></s></s> [MASK] [MASK]</s></s></s> [MASK] [MASK]</s> [MASK]</s></s></s></s>

Q: Provide a brief description of the given image. A: [MASK] image [MASK] a serene and beautiful [MASK] scene taken [MASK] [MASK] [MASK] [MASK] [MASK], which appears to be a [MASK] [MASK] [MASK] From [MASK] wooden balcony [MASK] [MASK] of a clear [MASK] [MASK] where the snowy town [MASK] the base [MASK] [MASK] horizon. [MASK] [MASK]′ [MASK] [MASK] ray [MASK] illuminate the landscape [MASK] casting [MASK] a warm glow [MASK] the azure backdrop [MASK]</s></s></s> [MASK] [MASK]</s></s>[MASK]</s></s></s></s></s></s></s></s> [MASK]</s></s> [MASK] [MASK]</s> [MASK] [MASK]</s> [MASK]</s></s></s> [MASK]</s> [MASK]</s></s> [MASK]</s></s></s></s> [MASK] [MASK]</s></s></s> [MASK] [MASK]</s> [MASK]</s></s></s></s>

Q: Provide a brief description of the given image. A: The image presents a serene and beautiful winter scene taken from a vantage point, which appears to be a mountain range. From the wooden balcony in front of a clear blue sky where the snowy town at the base meets the horizon. The sun's rays illuminate the landscape, casting a warm glow against the azure backdrop.

</s></s></s></s></s></s></s></s></s></s></s></s></s></s></s></s></s></s></s>
</s></s></s></s></s></s></s></s></s></s></s></s></s></s></s></s></s></s></s>
</s></s></s></s></s></s></s></s></s></s></s></s></s></s>

The systems and methods discussed above introduce an end-to-end multimodal diffusion model that bridges the gap between text and image diffusion by enabling both text-to-image (T2I) and image-to-text (I2T) tasks through a unified diffusion model architecture. The experiments discussed above demonstrate that a bidirectional transformer trained with a joint diffusion objective is an effective multimodal learner capable of competing with the autoregressive models that have long dominated the field. Additionally, the bidirectional attention mechanism is equivariant to the order of input tokens, enabling the prediction of conditional distributions without requiring a specific arrangement of different modalities or special handling of attention masks.

The above experiments further demonstrate that using the dual diffusion transformer architecture, a pretrained T2I model can be converted to also be capable of performing I2T generation and question answering. This finetuning can achieve competitive I2T generation and visual question-answering performance with small amounts of training text data, on the order of 1% of the amount of text typically used to train a generative language model. Using the dual diffusion transformer training approach, the natural language modeling capabilities learned by the T2I model during pretraining may accordingly be leveraged to perform I2T generation and question answering tasks.

I2T generation and question answering performed at the dual diffusion transformer can also be performed with increased parallelization compared to autoregressive I2T generation. Since autoregressive I2T generation computes output tokens by sampling from probability distributions that are conditioned on the previous output tokens in the output sequence, autoregressive text generators compute the output tokens serially. In contrast, the dual diffusion transformer is configured to replace mask tokens with output tokens in a manner that decouples token positions from output generation timesteps. This decoupling allows the dual diffusion transformer to generate the output text tokens in parallel, which may result in decreased inferencing latency.

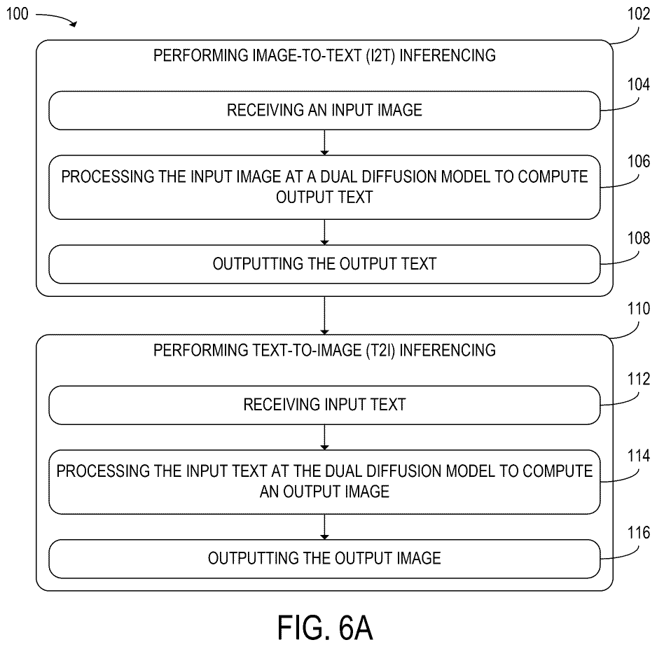

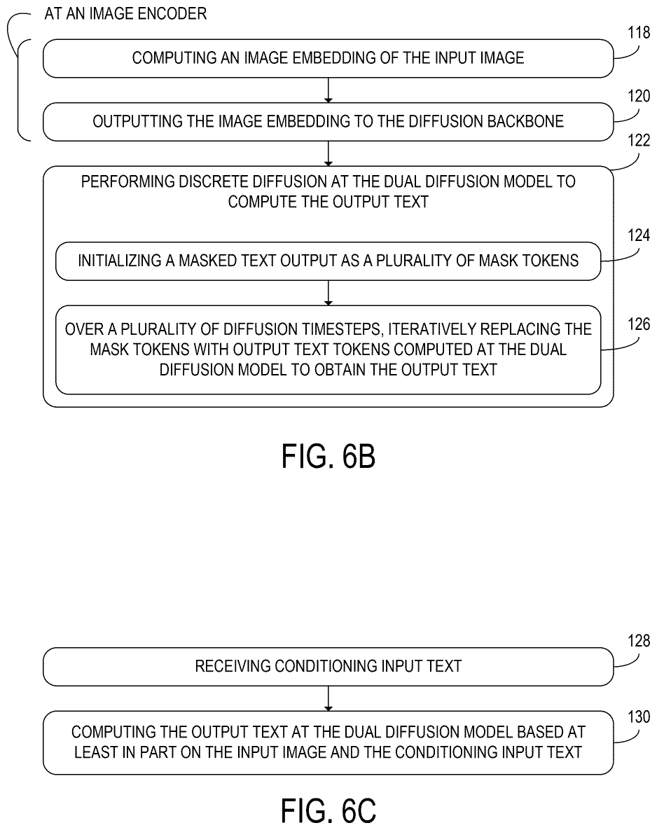

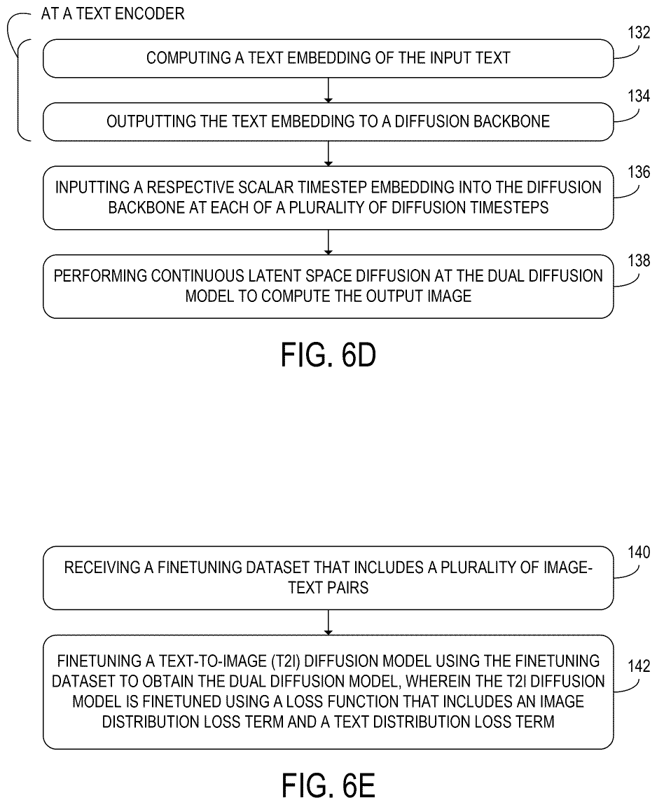

FIG. 6A shows a flowchart of a method 100 for use with a computing system to perform I2T and T2I generation at a dual diffusion model. At step 102, the method 100 includes performing image-to-text (I2T) inferencing. Performing I2T inferencing includes, at step 104, receiving an input image. At step 106, performing I2T inferencing further includes processing the input image at a dual diffusion model to compute output text. At step 108, performing I2T inferencing further includes outputting the output text.

At step 110, the method 100 further includes performing text-to-image (T2I) inferencing. Performing T2I inferencing includes, at step 112, receiving input text. At step 114, performing T2I inferencing further includes processing the input text at the dual diffusion model to compute an output image. At step 116, performing T2I inferencing further includes outputting the output image. Accordingly, the same dual diffusion model that computes the output text during I2T inferencing is also used to perform T2I generation.

FIGS. 6B-6F show additional steps of the method 100 that may be performed in some examples. The steps of FIG. 6B may be performed during I2T generation. Steps 118 and 120 may be performed at an image encoder included in the dual diffusion model. At step 118, the method 100 may further include computing an image embedding of the input image. At step 120, the method 100 may further include outputting the image embedding to the diffusion backbone. The diffusion backbone processes the image embedding to compute the output text. At step 122, the method 100 may further include performing discrete diffusion at the diffusion backbone of the discrete diffusion model to compute the output text.

In some examples, the discrete diffusion performed at step 122 is a masked diffusion process. In such examples, step 122 may include, at step 124 initializing a masked text output as a plurality of mask tokens. At step 126, step 122 may further include iteratively replacing the mask tokens with output text tokens computed at the dual diffusion model to obtain the output text. The mask tokens are replaced with the output text tokens over a plurality of diffusion timesteps. The dual diffusion model accordingly generates the output text in a manner that does not require autoregressive generation. Since autoregression is not required to generate the output text, the output text may be generated with increased parallelization, thereby resulting in a shorter inferencing time.

FIG. 6C shows additional steps that may be performed in some examples when I2T generation is performed. At step 128, the method 100 may further include receiving conditioning input text in addition to the input image. At step 130, the method 100 may further include computing the output text at the dual diffusion model based at least in part on the input image and the conditioning input text. For example, the dual diffusion model may perform text-conditioned I2T generation in an image captioning task or a visual question answering task.

FIG. 6D shows additional steps of the method 100 that may be performed when the dual diffusion model performs T2I generation. Steps 132 and 134 may be performed at a text encoder included in the dual diffusion model. At step 132, the method 100 may further include computing a text embedding of the input text. At step 134, the method 100 may further include outputting the text embedding to the diffusion backbone.

At step 136, during T2I generation, the method 100 may further include inputting a respective scalar timestep embedding into the diffusion backbone at each of a plurality of diffusion timesteps. Accordingly, the denoising performed at the diffusion backbone may be conditioned on an indication of the signal-to-noise ratio of the image, which may increase output image quality.

At step 138, during T2I generation, the method 100 may further include performing continuous latent space diffusion at the diffusion backbone of the dual diffusion model to compute the output image. Thus, the output image is generated by performing continuous diffusion conditioned on the text embedding.

FIG. 6E shows steps that may be performed during a training phase to train the dual diffusion model. At step 140, the method 100 may further include receiving a finetuning dataset that includes a plurality of image-text pairs. At step 142, the method 100 may further include finetuning a T2I diffusion model using the finetuning dataset to obtain the dual diffusion model. The T2I diffusion model is finetuned using a loss function that includes an image distribution loss term and a text distribution loss term. Thus, the T2I diffusion model is finetuned to also have I2T generation capabilities while preserving its performance at T2I generation.

The methods and processes described herein are tied to a computing system of one or more computing devices. In particular, such methods and processes can be implemented as a computer-application program or service, an application-programming interface (API), a library, and/or other computer-program product.

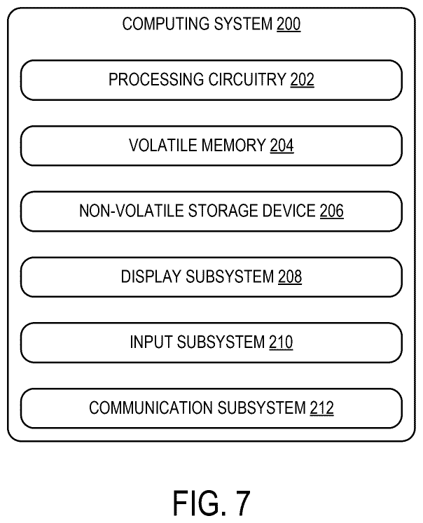

FIG. 7 schematically shows a non-limiting embodiment of a computing system 200 that can enact one or more of the methods and processes described above. Computing system 200 is shown in simplified form. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 7.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry 202 to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory 204, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device 206, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs provide additional description of the subject matter of the present disclosure. According to one aspect of the present disclosure, a computing system is provided, including one or more processing devices configured to, during an inferencing phase, receive an input image at a dual diffusion model. During the inferencing phase, the one or more processing devices are further configured to process the input image at the dual diffusion model to compute output text and output the output text. The dual diffusion model has been computed during a training phase by finetuning a text-to-image (T2I) diffusion model. The finetuning has been performed using a finetuning dataset that includes a plurality of image-text pairs. The finetuning has also used a loss function that includes an image distribution loss term and a text distribution loss term. The above features may have the technical effect of converting a T2I diffusion model to also perform image-to-text (I2T) generation.

According to this aspect, during the inferencing phase, the one or more processing devices may be further configured to receive input text at the dual diffusion model. The one or more processing devices may be further configured to process the input text at the dual diffusion model to compute an output image. The one or more processing devices may be further configured to output the output image. The above features may have the technical effect of performing T2I generation at the dual diffusion model.

According to this aspect, the dual diffusion model may include a diffusion backbone. The dual diffusion model may further include a text encoder configured to compute a text embedding of the input text and output the text embedding to the diffusion backbone. The above features may have the technical effect of converting the input text into a text embedding that is usable as an input of the diffusion backbone.

According to this aspect, computing the output image may further include inputting a respective scalar timestep embedding into the diffusion backbone at each of a plurality of diffusion timesteps. The above features may have the technical effect of conditioning image generation on an indication of the amount of denoising that has already been performed at the diffusion backbone during the generation of the output image.

According to this aspect, the one or more processing devices may be configured to perform continuous latent space diffusion at the dual diffusion model when computing the output image. The above features may have the technical effect of performing image denoising with high accuracy.

According to this aspect, the dual diffusion model may include a diffusion backbone. The dual diffusion model may further include an image encoder configured to compute an image embedding of the input image and output the image embedding to the diffusion backbone. The above features may have the technical effect of converting the input image into an image embedding that is usable as an input of the diffusion backbone.

According to this aspect, during the inferencing phase, the one or more processing devices may be further configured to receive conditioning input text. The one or more processing devices may be further configured to compute the output text at the dual diffusion model based at least in part on the input image and the conditioning input text. The above features may have the technical effect of performing I2T tasks such as image captioning and visual question answering that utilize conditioning text inputs in addition to image inputs.

According to this aspect, the one or more processing devices may be configured to perform discrete diffusion at the dual diffusion model when computing the output text. The above features may have the technical effect of selecting text tokens included in the output text from a discrete token vocabulary.

According to this aspect, to compute the output text during the inferencing phase, the one or more processing devices may be configured to initialize a masked text output as a plurality of mask tokens. Over a plurality of diffusion timesteps, the one or more processing devices may be further configured to iteratively replace the mask tokens with output text tokens computed at the dual diffusion model to obtain the output text. The above features may have the technical effect of increasing the parallelizability of output token generation compared to autoregressive text generation, thereby decreasing the latency of text generation.

According to another aspect of the present disclosure, a computing system is provided, including one or more processing devices configured to perform image-to-text (I2T) inferencing at least in part by receiving an input image, processing the input image at a dual diffusion model to compute output text, and outputting the output text. The one or more processing devices may be further configured to perform text-to-image (T2I) inferencing at least in part by receiving input text, processing the input text at the dual diffusion model to compute an output image, and outputting the output image. The above features may have the technical effect of using the dual diffusion model for both I2T and T2I generation.

According to this aspect, wherein the dual diffusion model may include a diffusion backbone. The dual diffusion model may further include a text encoder configured to compute a text embedding of the input text and output the text embedding to the diffusion backbone. The dual diffusion model may further include an image encoder configured to compute an image embedding of the input image and output the image embedding to the diffusion backbone. The above features may have the technical effect of converting the input text and input image into embeddings that are usable as inputs of the dual diffusion model.

According to this aspect, the I2T inferencing may be text-conditioned I2T inferencing in which the one or more processing devices are further configured to receive a conditioning text input and compute the output text at the dual diffusion model based at least in part on the input image and the conditioning text input. The above features may have the technical effect of performing I2T tasks such as image captioning and visual question answering that utilize conditioning text inputs in addition to image inputs.

According to this aspect, the one or more processing devices may be configured to perform continuous latent space diffusion at the dual diffusion model when computing the output image. The above features may have the technical effect of performing image denoising with high accuracy.

According to this aspect, the one or more processing devices may be configured to perform discrete diffusion at the dual diffusion model when computing the output text. The above features may have the technical effect of selecting text tokens included in the output text from a discrete token vocabulary.

According to this aspect, during the I2T inferencing, the one or more processing devices may be configured to initialize a masked text output as a plurality of mask tokens. Over a plurality of diffusion timesteps, the one or more processing devices may be further configured to iteratively replace the mask tokens with output text tokens computed at the dual diffusion model to obtain the output text. The above features may have the technical effect of increasing the parallelizability of output token generation compared to autoregressive text generation, thereby decreasing the latency of text generation.

According to another aspect of the present disclosure, a method for use with a computing system is provided. The method includes performing image-to-text (I2T) inferencing at least in part by receiving an input image, processing the input image at a dual diffusion model to compute output text, and outputting the output text. The method further includes performing text-to-image (T2I) inferencing at least in part by receiving input text, processing the input text at the dual diffusion model to compute an output image, and outputting the output image. The above features may have the technical effect of using the dual diffusion model for both I2T and T2I generation.

According to this aspect, the dual diffusion model may include a diffusion backbone, a text encoder, and an image encoder. The method may further include, at the text encoder, computing a text embedding of the input text and outputting the text embedding to the diffusion backbone. The method may further include, at the image encoder, computing an image embedding of the input image and outputting the image embedding to the diffusion backbone. The above features may have the technical effect of converting the input text and input image into embeddings that are usable as inputs of the dual diffusion model.

According to this aspect, the I2T inferencing may be text-conditioned I2T inferencing in which the method further includes receiving conditioning input text. The method may further include computing the output text at the dual diffusion model based at least in part on the input image and the conditioning input text. The above features may have the technical effect of performing I2T tasks such as image captioning and visual question answering that utilize conditioning text inputs in addition to image inputs.

According to this aspect, computing the output image may further include performing continuous latent space diffusion at the dual diffusion model. The above features may have the technical effect of performing image denoising with high accuracy.

According to this aspect, computing the output text may include performing discrete diffusion at the dual diffusion model. The above features may have the technical effect of selecting text tokens included in the output text from a discrete token vocabulary.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
during an inferencing phase:
receive an input image at a dual diffusion model;
process the input image at the dual diffusion model to compute output text; and
output the output text,
wherein the dual diffusion model has been computed during a training phase by finetuning a text-to-image (T2I) diffusion model, the finetuning having been performed using:
a finetuning dataset that includes a plurality of image-text pairs; and
a loss function that includes an image distribution loss term and a text distribution loss term.

2. The computing system of claim 1, wherein, during the inferencing phase, the one or more processing devices are further configured to:
receive input text at the dual diffusion model;
process the input text at the dual diffusion model to compute an output image; and
output the output image.

3. The computing system of claim 2, wherein the dual diffusion model includes:
a diffusion backbone; and
a text encoder configured to:
compute a text embedding of the input text; and
output the text embedding to the diffusion backbone.

4. The computing system of claim 2, wherein computing the output image further includes inputting a respective scalar timestep embedding into the diffusion backbone at each of a plurality of diffusion timesteps.

5. The computing system of claim 2, wherein the one or more processing devices are configured to perform continuous latent space diffusion at the dual diffusion model when computing the output image.

6. The computing system of claim 1, wherein the dual diffusion model includes:
a diffusion backbone; and
an image encoder configured to:
compute an image embedding of the input image; and
output the image embedding to the diffusion backbone.

7. The computing system of claim 1, wherein, during the inferencing phase, the one or more processing devices are further configured to:
receive conditioning input text; and
compute the output text at the dual diffusion model based at least in part on the input image and the conditioning input text.

8. The computing system of claim 1, wherein the one or more processing devices are configured to perform discrete diffusion at the dual diffusion model when computing the output text.

9. The computing system of claim 1, wherein, to compute the output text during the inferencing phase, the one or more processing devices are configured to:
initialize a masked text output as a plurality of mask tokens; and
over a plurality of diffusion timesteps, iteratively replace the mask tokens with output text tokens computed at the dual diffusion model to obtain the output text.

10. A computing system comprising:
one or more processing devices configured to:
perform image-to-text (I2T) inferencing at least in part by:
receiving an input image;
processing the input image at a dual diffusion model to compute output text; and
outputting the output text; and
perform text-to-image (T2I) inferencing at least in part by:
receiving input text;
processing the input text at the dual diffusion model to compute an output image; and
outputting the output image.

11. The computing system of claim 10, wherein the dual diffusion model includes:
a diffusion backbone;
a text encoder configured to:
compute a text embedding of the input text; and
output the text embedding to the diffusion backbone; and
an image encoder configured to:
compute an image embedding of the input image; and
output the image embedding to the diffusion backbone.

12. The computing system of claim 10, wherein the I2T inferencing is text-conditioned I2T inferencing in which the one or more processing devices are further configured to:
receive a conditioning text input; and
compute the output text at the dual diffusion model based at least in part on the input image and the conditioning text input.

13. The computing system of claim 10, wherein the one or more processing devices are configured to perform continuous latent space diffusion at the dual diffusion model when computing the output image.

14. The computing system of claim 10, wherein the one or more processing devices are configured to perform discrete diffusion at the dual diffusion model when computing the output text.

15. The computing system of claim 10, wherein, during the I2T inferencing, the one or more processing devices are configured to:
initialize a masked text output as a plurality of mask tokens; and
over a plurality of diffusion timesteps, iteratively replace the mask tokens with output text tokens computed at the dual diffusion model to obtain the output text.

16. A method for use with a computing system, the method comprising:
performing image-to-text (I2T) inferencing at least in part by:
receiving an input image;
processing the input image at a dual diffusion model to compute output text; and
outputting the output text; and
performing text-to-image (T2I) inferencing at least in part by:
receiving input text;
processing the input text at the dual diffusion model to compute an output image; and
outputting the output image.

17. The method of claim 16, wherein:
the dual diffusion model includes a diffusion backbone, a text encoder, and an image encoder; and
the method further comprises:
at the text encoder:
computing a text embedding of the input text; and
outputting the text embedding to the diffusion backbone; and
at the image encoder:
computing an image embedding of the input image; and
outputting the image embedding to the diffusion backbone.

18. The method of claim 16, wherein the I2T inferencing is text-conditioned I2T inferencing in which the method further comprises:
receiving conditioning input text; and
computing the output text at the dual diffusion model based at least in part on the input image and the conditioning input text.

19. The method of claim 16, wherein computing the output image includes performing continuous latent space diffusion at the dual diffusion model.

20. The method of claim 16, wherein computing the output text includes performing discrete diffusion at the dual diffusion model.
